(19) United States
(12) Patent Application Publication
(10) Pub. No.: US 2019/0309685 A1
(43) Pub. Date: Oct. 10, 2019

(54) FLUID INJECTION COOLING

(71) Applicant: United Technologies Corporation, Farmington, CT (US)

(72) Inventors: William P. Stillman, Sturbridge, MA (US); Lane Mikal Thornton, Tolland, CT (US); Matthew A. Devore, Rocky Hill, CT (US); Gavin Hendricks, Manchester, CT (US)

(21) Appl. No.: 15/946,251

(22) Filed: Apr. 5, 2018

(51) Int. Cl. F02C 7/18; F02C 3/06; F02C 7/30

(52) U.S. Cl. CPC F02C 7/185; F02C 3/06; F05D 2260/213; F05D 2220/323; F02C 7/30

(57) ABSTRACT

A gas turbine engine includes a compressor section, a combustor section downstream from the compressor section, and a turbine section downstream from the combustor section. The gas turbine engine also includes a water tank with an outlet, and an injector fluidically connected to the outlet of the water tank and to the turbine section. The injector is configured to direct steam from the water tank into the turbine section.

### BACKGROUND

The present disclosure relates to turbine cooling systems in gas turbine engines.

A gas turbine engine on an aircraft typically includes a fan section, a compressor section, a combustor section and a turbine section. Air entering the compressor section is compressed and delivered into the combustor section where it is mixed with fuel and ignited to generate a high-speed exhaust gas flow. Prior to entry into the combustor section, the compressed air exiting the compressor section may have a high temperature and may be traveling at a high velocity. In order to guide the air to the combustor, as well as to reduce the velocity of the compressed air and to condition it for combustion, the gas turbine engine may also include a diffuser case. After exiting the combustor, the high-speed exhaust gas flow expands through the turbine section to drive the compressor and the fan section. The high-speed exhaust gas flow in the turbine section has a high temperature and cooling of the components in the turbine section is required to reduce corrosion in the turbine section and to extend the life of the turbine section. Cooling in the turbine section is especially important during takeoff of the aircraft, takeoff being the hottest portion of the mission of the gas turbine engine.

Many gas turbine engines cool the turbine section by bleeding cooling flow from the compressor section or the diffuser case, routing the cooling flow through a heat exchanger to reduce the temperature of the cooling flow, and then supplying the flow to the turbine. The heat exchanger pulls cool air from the fan stream to reduce the temperature of the cooling flow, which reduces the performance of the fan section. In other designs, water is injected into the diffuser case at takeoff to cool the turbine and increase the mass flow through the turbine, resulting in increased thrust. However, injecting water into the diffuser also quenches the combustor, which can result in flameout in the combustor and unburnt fuel to exhaust from the gas turbine engine. In consideration of the above, a cooling system is needed that does not reduce the efficiency of the fan section or cause the gas turbine engine to exhaust unburnt fuel.

### SUMMARY

In one aspect of the invention, a gas turbine engine includes a compressor section, a diffuser case downstream from the compressor section, a combustor section downstream from the diffuser case, and a turbine section downstream from the combustor section. The gas turbine engine also includes a heat exchanger with a gas passage and a liquid tank. The gas passage includes an inlet fluidically connected to the compressor section or the diffuser case, and an outlet fluidically connected to the turbine section. The liquid tank envelopes at least a portion of the gas passage and includes an outlet that fluidically communicates with the turbine section downstream from the combustor section.

In another aspect of the invention, a method for cooling a gas turbine engine includes bleeding cooling flow from a core flow upstream of a combustor section. The method further includes reducing the temperature of the cooling flow by directing the cooling flow through a gas-water heat exchanger. The cooling flow from the gas-water heat exchanger is directed to the turbine section. Steam from a water side of the gas-water heat exchanger is directed into the turbine section.

In another aspect of the invention, a gas turbine engine includes a compressor section, a combustor section downstream from the compressor section, and a turbine section downstream from the combustor section. The gas turbine engine also includes a water tank with an outlet, and an injector fluidically connected to the outlet of the water tank and to the turbine section. The injector is configured to direct steam from the water tank into the turbine section.

Persons of ordinary skill in the art will recognize that other aspects and embodiments of the present invention are possible in view of the entirety of the present disclosure, including the accompanying figures.

### BRIEF DESCRIPTION OF THE DRAWINGS

FIG. 1 is a partial cross-sectional view of a gas turbine engine.

FIG. 2 is a schematic diagram of a compressor section, a combustor section, a turbine section, and an embodiment of a cooling system.

FIG. 3 is a schematic diagram of a compressor section, a combustor section, a turbine section, and another embodiment of a cooling system.

While the above-identified drawing figures set forth one or more embodiments of the invention, other embodiments are also contemplated. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings. Like reference numerals identify similar structural elements.

### DETAILED DESCRIPTION

The present disclosure provides a cooling system for protecting a turbine section of a gas turbine engine on an aircraft against thermal degradation and corrosion from the high temperatures of the high-speed exhaust gas flow entering the turbine section from the combustor section, especially during takeoff of the aircraft when the gas turbine engine is the hottest and most stressed. As described below with reference to the Figures, the cooling system includes a water tank that delivers steam to a tangential on-board injector that directs the steam into the turbine section.

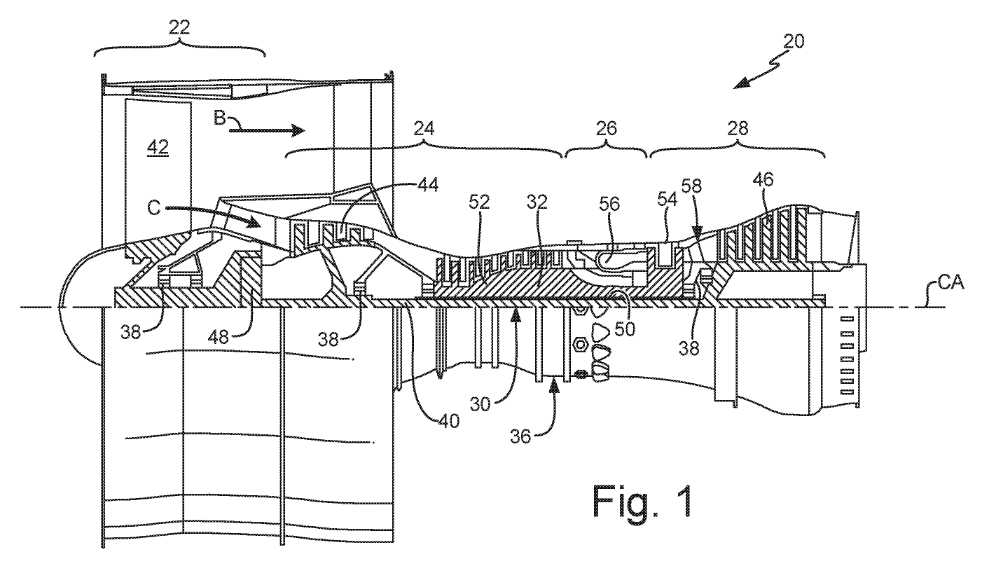

FIG. 1 is a quarter-sectional view that schematically illustrates example gas turbine engine 20 that includes fan section 22, compressor section 24, combustor section 26 and turbine section 28. Fan section 22 drives air along bypass flow path B while compressor section 24 draws air in along core flow path C where air is compressed and communicated to combustor section 26. In combustor section 26, air is mixed with fuel and ignited to generate a high pressure exhaust gas stream that expands through turbine section 28 where energy is extracted and utilized to drive fan section 22 and compressor section 24. Although the disclosed non-limiting embodiment depicts a turbofan gas turbine engine, it should be understood that the concepts described herein are not limited to use with turbofans as the teachings may be applied to other types of turbine engines including three-spool architectures.

The example gas turbine engine 20 generally includes low speed spool 30 and high speed spool 32 mounted for rotation about center axis CA of gas turbine engine 20 relative to engine static structure 36 via several bearing assemblies 38. It should be understood that various bearing assemblies 38 at various locations may alternatively or additionally be provided.

Low speed spool 30 generally includes inner shaft 40 that connects fan 42 and low pressure (or first) compressor section 44 to low pressure (or first) turbine section 46. Inner shaft 40 drives fan 42 through a speed change device, such as geared architecture 48, to drive fan 42 at a lower speed than low speed spool 30. High-speed spool 32 includes outer shaft 50 that interconnects high pressure (or second) compressor section 52 and high pressure (or second) turbine section 54. Inner shaft 40 and outer shaft 50 are concentric and rotate via bearing assemblies 38 about center axis CA.

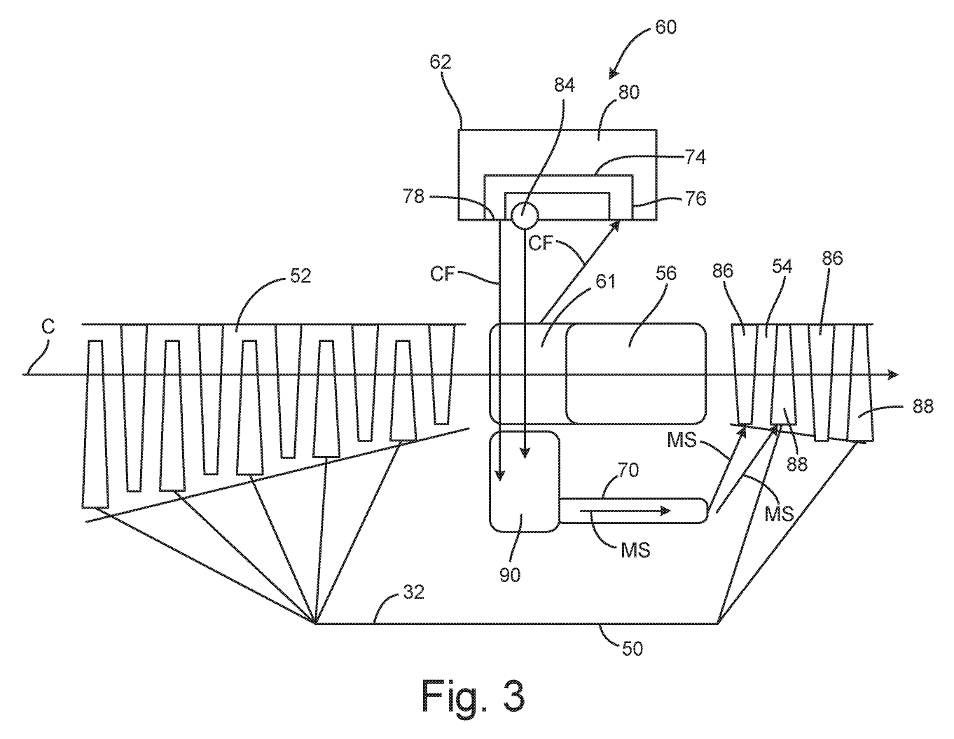

Combustor 56 is arranged between high pressure compressor 52 and high pressure turbine 54. Mid-turbine frame 58 of engine static structure 36 can be arranged generally between high pressure turbine 54 and low pressure turbine 46. Mid-turbine frame 58 further supports bearing assemblies 38 in turbine section 28 as well as setting airflow entering the low pressure turbine 46. The core airflow C is compressed first by low pressure compressor 44 and then by high pressure compressor 52 mixed with fuel and ignited in combustor 56 to produce high speed exhaust gases that are then expanded through high pressure turbine 54, mid-turbine frame 58, and low pressure turbine 46. The high speed exhaust gases have an extremely high temperature as they enter high pressure turbine 54 from combustor 56. The core airflow C at the exit of high pressure compressor 52 also has a relatively high temperature due to the high pressure of core airflow C exiting high pressure compressor 52. As discussed below with reference to FIG. 3, cooling system 60 provides cooling air to high pressure turbine 54 and high pressure compressor 52 to cool and protect the components of high pressure turbine 54 and high pressure compressor 52 against thermal degradation and corrosion.

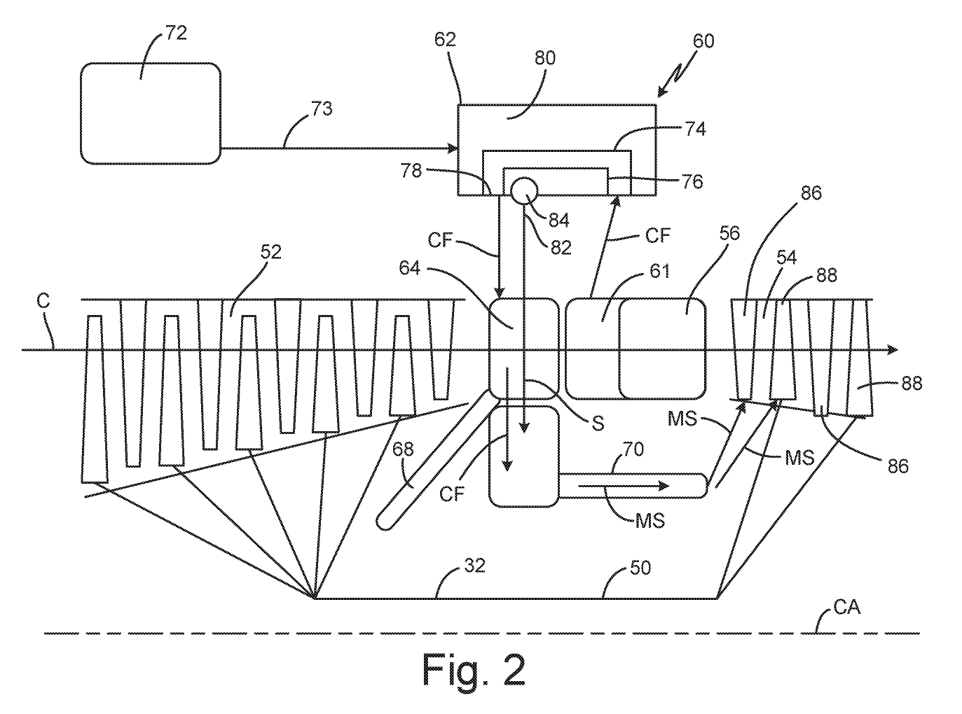

FIG. 2 is a schematic diagram of high pressure compressor 52, combustor 56, high pressure turbine 54, cooling system 60, and diffuser case 61. As shown in the embodiment of FIG. 2, cooling system 60 includes heat exchanger 62, outer mixing chamber 64, inner mixing chamber 66, compressor on-board injector (COBI) 68, tangential on-board injector (TOBI) 70, refill tank 72, and refill line 73. Heat exchanger 62 includes gas passage 74 with inlet 76 and outlet 78. Heat exchanger 62 further includes water tank 80 with outlet 82 and valve 84. High pressure turbine 54 includes vanes 86, and rotors 88.

Diffuser case 61 is downstream from high pressure compressor 52 and upstream of combustor 56. Diffuser case 61 guides and reduces the velocity of core airflow C before core airflow C enters combustor 56. Inside combustor 56, core airflow C is mixed with fuel, ignited, and exhausted into high pressure turbine 54 downstream from combustor 56. Vanes 86 of high pressure turbine 54 guide and turn the exhausted flow while rotors 88 extract work from the flow to power high pressure compressor 52. Cooling system 60 cools high pressure compressor 52 and high pressure turbine 54 by bleeding cooling air CF from core airflow C in diffuser case 61 and/or high pressure compressor 52, reducing the temperature of cooling air CF in heat exchanger 62, and injecting cooling air CF into high pressure compressor 52 and high pressure turbine 54. To further cool high pressure turbine 54, cooling system 60 can deliver steam S from heat exchanger 62 into high pressure turbine 54.

Heat exchanger 62 is a gas-water heat exchanger. Gas passage 74 forms a gas side of heat exchanger 62 and water tank 80 forms a water side of heat exchanger 62. Gas passage 74 extends between inlet 76 and outlet 78. In the embodiment of FIG. 2, inlet 76 of gas passage 74 is fluidically connected diffuser case 61. Outlet 78 of gas passage 74 is fluidically connected to outer mixing chamber 64. Gas passage 74 bleeds and transports cooling air CF from diffuser case 61 to outer mixing chamber 64. At least a portion of gas passage 74 extends through water tank 80 and is enveloped by water tank 80. As cooling air CF travels through gas passage 74, heat is transferred from cooling air CF to the water in water tank 80. After passing through gas passage 74, cooling air CF is delivered through outlet 78 and into outer mixing chamber 64. COBI 68 is connected to outer mixing chamber 64 and high pressure compressor 52 and delivers a portion of cooling air CF in outer mixing chamber 64 to high pressure compressor 52 to cool high pressure compressor 52.

Inner mixing chamber 66 is fluidically connected to outer mixing chamber 64 and is positioned radially inward of outer mixing chamber 64 relative engine center axis CA. A portion of cooling flow CF in outer mixing chamber 66 is transferred to inner mixing chamber 66. TOBI 70 is connected to inner mixing chamber 66 and high pressure turbine 54 and directs cooling flow CF in inner mixing chamber 66 into high pressure turbine 54 to cool high pressure turbine 54. Outlet 82 of water tank 80 is connected to inner mixing chamber 66, and valve 84 is connected to outlet 82 to close and open outlet 82.

As heat is transferred into water tank 80 from gas passage 74, steam S is produced inside water tank 80. Once the pressure of steam S exceeds a predetermined set value, valve 84 is opened and steam S is delivered directly into inner mixing chamber 66 from outlet 82 of water tank 80. Steam S is mixed with cooling flow CF in inner mixing chamber 66, and the steam-cooling flow mixture MS is delivered to high pressure turbine 54 by TOBI 70. TOBI 70 can inject the steam-cooling flow mixture MS directly into the core flow of high pressure turbine 54. TOBI 70 can also be connected to cooling passages (not shown) inside vanes 86 and rotors 88 of high pressure turbine 54, and TOBI 70 can direct the steam-cooling flow mixture MS into the cooling passages of vanes 86 and rotors 88. After entering vanes 86 and rotors 88, the steam-cooling flow mixtures MS can bleed out of vanes 86 and rotors 88 and into the core flow via cooling holes (not shown) formed in vanes 86 and rotors 88. In summary, inner mixing chamber 66 and TOBI 70 fluidically connect water tank 80 to high pressure turbine 54 and deliver steam S in addition to cooling flow CF to high pressure turbine 54. Outer mixing chamber 64 and COBI 68 do not receive or deliver steam S to high pressure compressor 52, thus, steam S is only introduced into the core flow downstream of combustor 56. Steam S can be delivered to high pressure turbine 54 only during the peak operating levels of gas turbine engine 20, such as during takeoff of an aircraft employing gas turbine engine 20, when the temperatures inside high pressure turbine 54 traditionally reach their maximum level. By introducing steam into high pressure turbine 54 during takeoff, the temperatures inside high pressure turbine 54 do not reach the same maximums as experienced in prior art gas turbine engines. With maximum temperatures reduced inside high pressure turbine 54, high pressure turbine 54 can be built lighter to offset the weight of water tank 80.

Refill tank 72 is a water storage tank connected to water tank 80 by refill line 73 and refills water tank 80 with water as steam S leaves water tank 80. While water tank 80 and heat exchanger 62 are located on gas turbine engine 20, refill tank 72 can be located off of gas turbine engine 20, such as in a fuselage or wing of an aircraft. Cleaning agents (not shown) can be added to the water in refill tank 72 and water tank 80. The cleaning agents added to the water in refill tank 72 and water tank 80 can be transferred to high pressure turbine 54 with steam S to clean the components of high pressure turbine 54 during operation of gas turbine engine 20.

FIG. 3 is a schematic diagram with another embodiment of cooling system 60 with a single mixing chamber 90. As shown in FIG. 3, both outlet 78 of gas passage 74 and outlet 82 of water tank 80 are connected directly to mixing chamber 90. Mixing chamber 90 receives cooling flow CF from outlet 78 of gas passage 74 and steam S from outlet 82 of water tank 80. Cooling flow CF and steam S mix together inside mixing chamber 90 into a combined steam-cooling flow mixture MS. The steam-cooling flow mixture MS is delivered to high pressure turbine 54 by tangential on-board injector (TOBI) 70, which is connected to mixing chamber 90 and high pressure turbine 54. In other embodiments, steam S can be carried in water-tight passages (not shown) through combustor 56 to cool combustor 56 before steam S is directed into high pressure turbine 54 and released into the core flow in high pressure turbine 54. The water-tight passages can be channels (not shown) formed in the paneling of combustor 56, or small finned tubes formed between panels of combustor 56. Steam S is not released into combustor 56 so as to avoid flameout or over-quench.

In view of the foregoing description, it will be recognized that the present disclosure provides numerous advantages and benefits. For example, the present disclosure provides cooling system 60 with water tank 80. Water tank 80 provides a source for steam S that is injected into high pressure turbine 54 via mixing chambers 66/90 and TOBI 70. Cooling system 60 injects steam into high pressure turbine 54, which cools high pressure turbine 54 more effectively than cooling air alone. Because steam S is injected directly into high pressure turbine 54, steam S does not impact the performance of combustor 56 or cause flameout in combustor 56.

The following are non-exclusive descriptions of possible embodiments of the present invention.

In one embodiment, a gas turbine engine includes a compressor section, a diffuser case downstream from the compressor section, a combustor section downstream from the diffuser case, and a turbine section downstream from the combustor section. The gas turbine engine also includes a heat exchanger with a gas passage and a liquid tank. The gas passage includes an inlet fluidically connected to the compressor section or the diffuser case, and an outlet fluidically connected to the turbine section. The liquid tank envelopes at least a portion of the gas passage and includes an outlet that fluidically communicates with the turbine section downstream from the combustor section.

The gas turbine engine of the preceding paragraph can optionally include, additionally and/or alternatively, any one or more of the following features, configurations and/or additional components:

a valve connected to the outlet of the liquid tank, wherein the valve is configured to open when pressure in the liquid tank exceeds a set value;

a mixing chamber is connected to the outlet of the liquid tank and configured to receive steam from the outlet of the liquid tank;

a tangential on-board injector is connected to the mixing chamber and the turbine section, wherein the tangential on-board injector is configured to receive steam from the mixing chamber and direct the steam to the turbine section; and/or

the tangential on-board injector is connected to cooling passages inside airfoils in the turbine section.

In another embodiment, a method for cooling a gas turbine engine includes bleeding cooling flow from a core flow upstream of a combustor section. The method further includes reducing the temperature of the cooling flow by directing the cooling flow through a gas-water heat exchanger. The cooling flow from the gas-water heat exchanger is directed to the turbine section. Steam from a water side of the gas-water heat exchanger is directed into the turbine section.

The method of the preceding paragraph can optionally include, additionally and/or alternatively, any one or more of the following features, configurations and/or additional components:

the steam is directed into the turbine section when pressure inside the water side of the gas-water heat exchanger exceeds a set value;

the steam is carried in water-tight passages through the combustor section before the steam is directed into the turbine section and released in the turbine section.

refilling the water side of the gas-water heat exchanger with water from a storage tank;

cleaning the turbine section by adding cleaning agents into the water side of the gas-water heat exchanger and directing the cleaning agents to the turbine section when the steam from the water side of the gas-water heat exchanger is directed into the turbine section;

the steam is directed into cooling passages inside airfoils in the turbine section and bled into the core flow via cooling holes in the airfoils; and/or

mixing the steam and at least a portion of the cooling flow before directing the steam into the turbine section.

In another embodiment, a gas turbine engine includes a compressor section, a combustor section downstream from the compressor section, and a turbine section downstream from the combustor section. The gas turbine engine also includes a water tank with an outlet, and an injector fluidically connected to the outlet of the water tank and to the turbine section. The injector is configured to direct steam from the water tank into the turbine section.

The gas turbine engine of the preceding paragraph can optionally include, additionally and/or alternatively, any one or more of the following features, configurations and/or additional components:

a heat exchanger comprising: the water tank; and a gas passage with an inlet fluidically connected to the compressor section and an outlet fluidically connected to the injector, wherein the gas passage is in thermal communication with the water tank; and a valve between the outlet of the water tank and the injector, wherein the valve is configured to open when pressure in the water tank exceeds a set value.

at least a portion of the gas passage extends through the water tank;

the outlet of the gas passage is connected to a first mixing chamber, and the first mixing chamber is connected to a second mixing chamber;

the second mixing chamber is radially inward from the first mixing chamber relative a center axis of the gas turbine engine;

the second mixing chamber connects the outlet of the water tank to the injector, and wherein the injector is a tangential on-board injector (TOBI);

a compressor on-board injector (COBI) fluidically connects the first mixing chamber to the compressor section; and/or

the injector is connected to cooling passages inside airfoils in the turbine section.

Any relative terms or terms of degree used herein, such as “substantially”, “essentially”, “generally”, “approximately”, and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, transitory vibrations and sway movements, temporary alignment or shape variations induced by operational conditions, and the like.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A gas turbine engine comprising:
a compressor section;
a diffuser case downstream from the compressor section;
a combustor section downstream from the diffuser case;
a turbine section downstream from the combustor section; and
a heat exchanger comprising:
a gas passage with an inlet fluidically connected to the compressor section or the diffuser case and an outlet fluidically connected to the turbine section; and
a liquid tank enveloping at least a portion of the gas passage, wherein the liquid tank comprises an outlet that fluidically communicates with the turbine section downstream from the combustor section.

2. The gas turbine engine of claim 1, further comprising:
a valve connected to the outlet of the liquid tank, wherein the valve is configured to open when pressure in the liquid tank exceeds a set value.

3. The gas turbine engine of claim 1, wherein a mixing chamber is connected to the outlet of the liquid tank and configured to receive steam from the outlet of the liquid tank.

4. The gas turbine engine of claim 3, wherein a tangential on-board injector is connected to the mixing chamber and the turbine section, wherein the tangential on-board injector is configured to receive steam from the mixing chamber and direct the steam to the turbine section.

5. The gas turbine engine of claim 4, wherein the tangential on-board injector is connected to cooling passages inside airfoils in the turbine section.

6. A method for cooling a gas turbine engine, the method comprising:
bleeding cooling flow from a core flow upstream of a combustor section;
reducing the temperature of the cooling flow by directing the cooling flow through a gas-water heat exchanger;
directing the cooling flow from the gas-water heat exchanger to the turbine section; and
directing steam from a water side of the gas-water heat exchanger into the turbine section.

7. The method of claim 6, wherein the steam is directed into the turbine section when pressure inside the water side of the gas-water heat exchanger exceeds a set value.

8. The method of claim 6, wherein the steam is carried in water-tight passages through the combustor section before the steam is directed into the turbine section and released in the turbine section.

9. The method of claim 6 further comprising:
refilling the water side of the gas-water heat exchanger with water from a storage tank.

10. The method of claim 6 further comprising:
cleaning the turbine section by adding cleaning agents into the water side of the gas-water heat exchanger and directing the cleaning agents to the turbine section when the steam from the water side of the gas-water heat exchanger is directed into the turbine section.

11. The method of claim 6, wherein the steam is directed into cooling passages inside airfoils in the turbine section and bled into the core flow via cooling holes in the airfoils.

12. The method of claim 6, further comprising:
mixing the steam and at least a portion of the cooling flow before directing the steam into the turbine section.

13. A gas turbine engine comprising:
a compressor section;
a combustor section downstream from the compressor section;
a turbine section downstream from the combustor section; and
a water tank comprising an outlet; and
an injector fluidically connected to the outlet of the water tank and to the turbine section, wherein the injector is configured to direct steam from the water tank into the turbine section.

14. The gas turbine engine of claim 13, further comprising:
a heat exchanger comprising:
the water tank; and
a gas passage with an inlet fluidically connected to the compressor section and an outlet fluidically connected to the injector, wherein the gas passage is in thermal communication with the water tank; and
a valve between the outlet of the water tank and the injector, wherein the valve is configured to open when pressure in the water tank exceeds a set value.

15. The gas turbine engine of claim 14, wherein at least a portion of the gas passage extends through the water tank.

16. The gas turbine engine of claim 14, wherein the outlet of the gas passage is connected to a first mixing chamber, and the first mixing chamber is connected to a second mixing chamber.

17. The gas turbine engine of claim 16, wherein the second mixing chamber is radially inward from the first mixing chamber relative a center axis of the gas turbine engine.

18. The gas turbine engine of claim 16, wherein the second mixing chamber connects the outlet of the water tank to the injector, and wherein the injector is a tangential on-board injector (TOBI).

19. The gas turbine engine of claim 18, wherein a compressor on-board injector (COBI) fluidically connects the first mixing chamber to the compressor section.

20. The gas turbine engine of claim 13, wherein the injector is connected to cooling passages inside airfoils in the turbine section.
